(19) United States
(12) Patent Application Publication
(10) Pub. No.: US 2017/0269561 A1
(43) Pub. Date: Sep. 21, 2017

(54) COMPUTING ENGINE, SOFTWARE, SYSTEM AND METHOD

(71) Applicant: INVREA Ltd., Witney (GB)

(72) Inventors: Frank Wood, Witney (GB); Mike Wu, Witney (GB); Yura Perov, Witney (GB); Hongseok Yang, Witney (GB)

(21) Appl. No.: 15/465,131

(22) Filed: Mar. 21, 2017

Related U.S. Application Data
(60) Provisional application No. 62/311,312, filed on Mar. 21, 2016.

(51) Int. Cl. G05B 13/04

(52) U.S. Cl. CPC G05B 13/041

(57) ABSTRACT

There is provided a computing engine (10) for use in simulating a complex system (20), controlling the complex system (20), or a combination of simulating and controlling the complex system (20), wherein the computing engine (10) includes a data processing arrangement (40) that is operable to execute one or more program instructions. The computing engine (10) includes a plurality of computational modules (50) that are operable to exchange data therebetween via a data exchange arrangement (60). The computational modules (50) are operable to execute one or more computational functions therein on data received at the computational modules (50) and to generate corresponding output data (R). The computational modules (50) are operable to receive, for input data to their one or more computational functions, at least one of: user input values, sensed data from the complex system (20). The computational modules (50) are operable to output their corresponding output data (R) for at least one of: user presentation, for controlling operation of the complex system (20). The computing engine (10) is operable to enable at least one of: constraining of the output data (R) by way of an actual feature, automatically creating by way of a create feature the one or more computational functions by way of constraining of the out data (R) by way of an actual feature, interpolating between discrete stochastic output results present in the output data (R) by way of an interpolation feature to determine intermediate stochastic output results lying between the discrete stochastic output results. There is also provided a system including a complex system (20) and the computing engine (10), wherein the computing engine (10) is operable to receive one or more sensor signals (S2) from the complex system (20), and to provide one or more control output signals (Q) for controlling operation of the complex system (20). The complex system includes, for example, a nuclear power plant, a greenhouse, a driverless vehicle, an aircraft, a robot, a militant apparatus, but not limited thereto.

### TECHNICAL FIELD

The present disclosure relates to systems, for example to systems controlled or simulated, or a combination of cont sled and simulated, by computing engines, for example computer-based controllers. Moreover, the present disclosure relates to software for use with the computing engines. Moreover, the present disclosure relates to computing engines that are operable to perform computations for controlling or simulating, or a combination of controlling and simulating, aforementioned systems; the computing engines are implementable using conventional computing hardware, or by employing a custom configuration of computing hardware. Moreover, the present disclosure relates to methods of using aforementioned computing engines and software for controlling or simulating, or a is combination of controlling and simulating, systems. The system are, for example, industrial processes, processes susceptible to stochastic variation, and complex systems having a very large number of potential physical states that evades control or simulation, or a combination of control and simulation, using conventional known techniques. The aforementioned software is concerned with computer program products comprising a non-transitory computer-readable storage medium having computer-readable instructions stored thereon, the computer-readable instructions being executable by a computerized device comprising processing hardware to execute aforesaid methods.

### BACKGROUND

Control devices for controlling systems, for example a thermostat for controlling a domestic central heating system, are well known, and countless patents have earlier been granted for such thermostats. Domestic premises, when being temperature controlled, are generally first-order thermal systems, wherein variations of heat energy input from their heating systems result in a sluggish first-order temporal change of temperature within the domestic premises. However, the domestic premises are subject to stochastic effects of doors and/or windows being opened at random, and forced wind cooling of the premises being a function of external weather conditions. The weather conditions will generally follow seasonal variations, but will also have a random stochastic component as well.

If the temperature of the domestic premises are to be precision controlled, or an optimal manner of operating the heating systems is to be attained, for example for providing most frugal use of hydrocarbon fuel for the heating systems, the thermostat needs to be considerably more complex in its operating function, in comparison to a simple binary ON/OFF device that is substantially immediately responsive to room air temperature relative to a temperature set point.

As system complexity increases, for example a complex aircraft, a nuclear power station or an industrial manufacturing facility with a plurality of concurrent manufacturing processes that are required to be mutually coordinated and feed intermediate products between the processes, controlling the processes can be extremely complex, for example in an event of delays of key components being delay in a random stochastic manner, or yield from the manufacturing processes varies in a stochastic unpredictable manner. Moreover, such system may have system states that are not allowable or are undesirable from a safety point of view, for example a nuclear power plant such as at Fukushima Dai'ichi, Japan.

Simulating and controlling such very complex systems is an enormous computing task, and it is in some situations not possible to explore and verify all potential states of the systems. In an event that such control involves simulating at least a part of a system, for example in an event that a part of the system cannot be monitored directly using suitable sensors, simulating a chaotic stochastic process involving a plurality of iterations can result in a huge number of results, especially when Monte Carlo simulation techniques are employed.

Contemporary software is known including one or more modules also known as “cells”, wherein one or more computational functions can be assigned to each module, wherein each module is operable to generate a computation result, for example for display or control, and one or more modules are operable to pass their computational result as input to other of the one or more modules are known, for example as in a conventional Excel® software. Computational results from the one or more modules can be presented in graphical form, for example tor benefit of users when devising and adjusting software for controlling or simulating, or a combination of both controlling and simulating, systems. In general, the computations occurring within the one or more modules are user-defined, and are susceptible to being subsequently edited or adjusted.

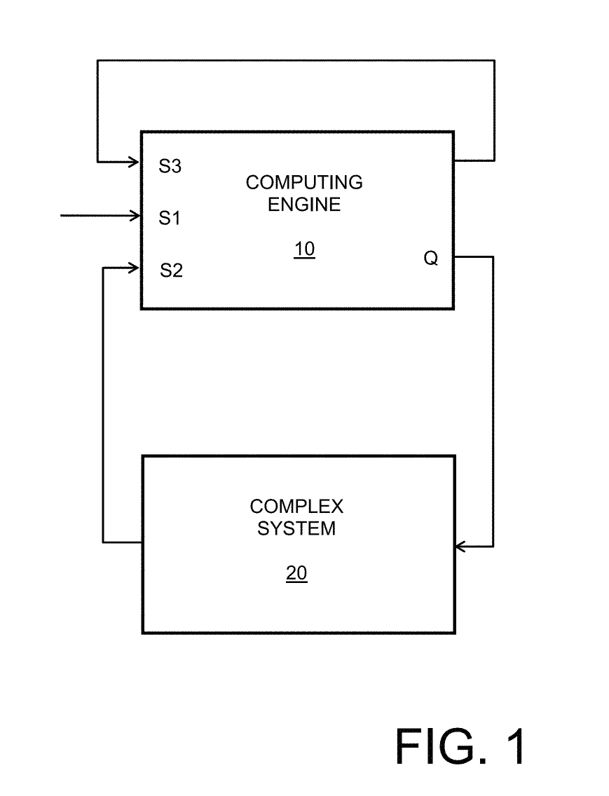

Referring to FIG. 1, there is shown an illustration of a known computing engine 10. The computing engine 10 is, for example, useable as a controller for controlling a complex system 20, for example an aircraft, power station, chemical plant, self-drive vehicle or similar. The computing engine 10 has one or more control inputs S1, one or more outputs Q, for example driving the complex system 20, one or more inputs S2 for receiving feedback from the complex system 20, and one or more inputs S3 generated by the computing engine 10 that iteratively returned to the computing engine 10 for assisting its computations. The computing engine 10 is, for example, is implemented using a conventional von Neumann computing architecture, for example a dual-core or quad-core processor arrangement, and employs the aforementioned Excel® software or a functional variant thereof.

For controlling the complex system 20, there may arise stochastic processes within the complex system 20 that have to be accommodated. When the computing engine 10 employs a degree of simulation, the simulation may require stochastic data, for example from a random number generator, that potentially results in a large number of potential simulation results, especially when the simulation employs Monte Carlo modelling techniques. Such a scenario arises, for example, in a case of a greenhouse controller, wherein the greenhouse controller has to anticipate whether or not to activate a heating system of a greenhouse and/or to open ventilation windows of the greenhouse, that has to anticipate future weather conditions, based on a combination of received weather forecast information and internal stochastic assumptions employed in the greenhouse controller.

Conventional approaches for implementing the computing engine 10 have generally required very large computing resources, and are very difficult for users and designers to configure. As a result of such complexity, many complex contemporary systems are inadequately controlled, resulting in inefficient operation, unsafe operation, or erratic operation. In a case of an aircraft or nuclear power plant, unsafe operation can be catastrophic practical consequences. Thus, there are many problems associated with using and configuring conventional known computing engines for performing simulation or control, or a combination of simulation and control. Moreover, there is a need for more advanced software for use in implementing such computing engines.

### SUMMARY

The present invention seeks to provide a computing engine that is operable to provide improved simulation or control of complex systems, or a combination improved simulation and control.

Moreover, the present invention seeks to provide a system whose operation is improved by using the aforementioned computing engine that is operable to provide improved simulation or control of complex systems, or a combination improved simulation and control.

Furthermore, the present invention seeks to provide program instructions, namely a software product, for use with the aforementioned computing engine for providing improved simulation or control of complex systems, or a combination improved simulation and control.

According to a first aspect, there is provided a computing engine for use in simulating a complex system, controlling the complex system, or a combination of simulating and controlling the complex system, wherein the computing engine includes a data processing arrangement that is operable to execute one or more program instructions.

wherein the computing engine includes a plurality of computational modules that are operable to exchange data therebetween via a data exchange arrangement,

wherein the computational modules are operable to execute one or more computational functions therein on data received at the computational modules and to generate corresponding output data (R),

wherein the computational modules are operable to receive, for input data to their one or more computational functions, at least one of: user input values, sensed data from the complex system,

wherein the computational modules are operable to output their corresponding output data (R) for at least one of: user presentation, for controlling operation of the complex system),

characterized in that the computing engine is operable to enable at least one of: constraining of the output data (R) by way of an actual feature, automatically creating by way of a create feature the one or more computational functions by way of constraining of the output data (R) by way of an actual feature, interpolating between discrete stochastic output results present in the output data (R) by way of an interpolation feature to determine intermediate stochastic output results lying between the discrete stochastic output results.

The present invention is of advantage in that use of least one of the actual feature, the create feature and the interpolation feature is capable of improving operation of the computing engine when simulating a complex system, controlling the complex system, or a combination of simulating and controlling the complex system.

Optionally, the computing engine is operable, to generate a user spreadsheet presentation, for enabling user defining of the one or more computational functions of the computational modules and user defining of the user input values. More optionally, the computing engine is implemented such that at least one of the actual feature, the create feature and the interpolation feature are invoked from a selection presented in a toolbar of the spreadsheet presentation.

Optionally, the computing engine is implemented such that the data processing arrangement is implemented as an array of computing structures that are operable to exchange data therebetween, and to perform repetitive computations for simulating or controlling, or simulating and controlling, trajectories of one or more assets.

Optionally, the computing engine is implemented using at least one of: computing hardware, custom hardware logic, a digital array processing arrangement.

According to a second aspect, there is provided a system including a complex system and a computing engine according to the first aspect, characterized in that the computing engine is operable to receive one or more sensor signals (S2) from the complex system, and to provide one or more control output signals (Q) for controlling operation of the complex system.

Optionally, the complex system includes at least one of: a nuclear power plant, a greenhouse, a driverless vehicle, an aircraft, a robot, a military apparatus, but is not limited thereto.

According to a third aspect, there is provided a method of operating a computing engine for use in simulating a complex system, controlling the complex system, or a combination of simulating and controlling the complex system, wherein the computing engine includes a data processing arrangement that is operable to execute one or more program instructions, characterized in that the method includes:
(a) arranging for the computing engine to include a plurality of computational modules (50) that are operable to exchange data therebetween via a data exchange arrangement (60);
(b) arranging for the computational modules to be operable to execute one or more computational functions therein on data received at the computational modules and to generate corresponding output data (R);
(c) arranging for the computational modules to be operable to receive, for input data to their one or more computational functions, at least one of: user input values, sensed data from the complex system;
(d) arranging for the computational modules to be operable to output their corresponding output data (R) for at least one of: user presentation, for controlling operation of the complex system; and
(e) operating the computing engine to enable at least one of: constraining of the output data (R) by way of an actual feature, automatically creating by way of a creation feature the one or more computational functions by way of constraining of the out data (R) by way of an actual feature, interpolating between discrete stochastic output results present in the output data (R) by way of an interpolation feature to determine intermediate stochastic output results lying between the discrete stochastic output results.

Optionally, the method includes operating the computing engine to generate a user spreadsheet presentation, for enabling user defining of the one or more computational functions of the computational modules and user defining of the user input values. More optionally, the method includes invoking at least one of the actual feature, the create feature and the interpolation feature from a selection presented in a toolbar of the spreadsheet presentation.

Optionally, the method includes implementing the data processing arrangement as an array of computing structures that are operable to exchange data therebetween, and to perform repetitive computations for simulating or controlling, or simulating and controlling, trajectories of one or more assets.

Optionally, the method includes implementing the computing engine using at least one of: computing hardware, custom hardware logic, a digital array processing arrangement.

According to a fourth aspect, there is provided a computer program product comprising a non-transitory computer-readable storage medium having computer-readable instructions stored thereon, the computer-readable instructions being executable by a computerized device comprising processing hardware to execute a method of the third aspect.

According to a fifth aspect, there is provided a method of transforming in a computing engine a data-flow program into a constrained probabilistic data-flow program, utilizing a plurality of addresses, by using a mechanism that performs a source code transformation, as an alternative to performing a value replacement at each indicated address.

According to a sixth aspect, there is provided a method of executing in a computing engine a data-flow program by repeatedly applying an existing data-flow program execution mechanism to the transformed data-flow program.

According to a seventh aspect, there is provided a method of executing a probabilistic data-flow program in a computing engine by compiling a probabilistic data-flow program to another probabilistic programming language, and using an existing probabilistic program execution mechanism to execute the transformed program on the computing engine or over a data communication network including a data processing arrangement (“cloud computing”).

According to an eighth aspect, there is provided a computer program product comprising a non-transitory computer-readable storage medium having computer-readable instructions stored thereon, the computer-readable instructions being executable by a computerized device comprising processing hardware to execute a method of any one of fifth, sixth and seventh aspects.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

FIG. 1 is a schematic illustration of a computing engine coupled to a complex system, for purposes of simulating or controlling the complex system, or a combination of simulating and controlling the complex system;

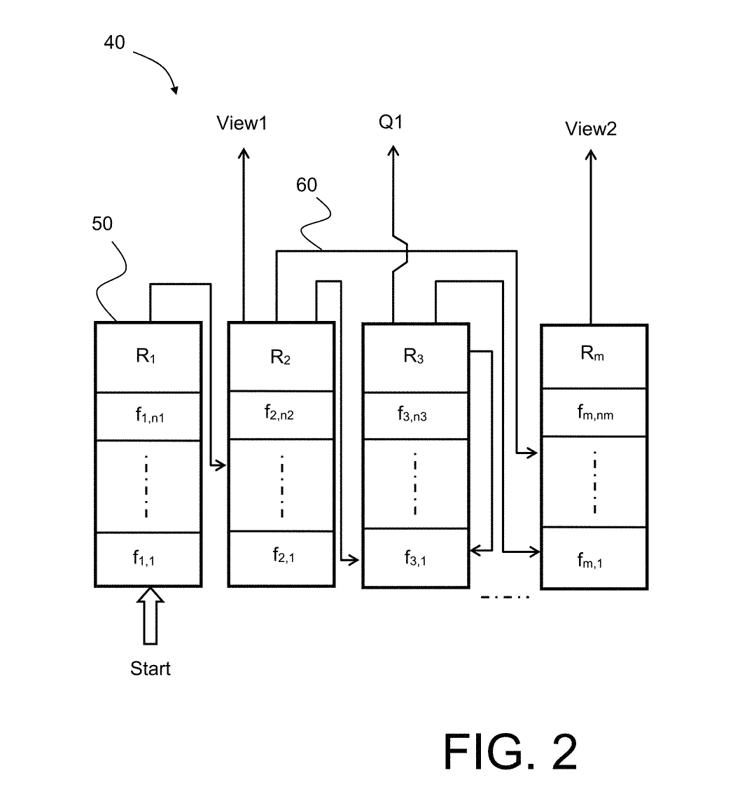

FIG. 2 is a schematic illustration of a computational structure employed in the computing engine of FIG. 1, wherein the computational structure includes a plurality of computational modules, for example presented as “cells” in a spread-sheet generated by a graphical user interface (GUI), wherein computational results from given computational modules are used as input to other given computational modules, wherein results from other given computational modules are employed in an iterative manner in computations of the other given computational modules, wherein results from given computational modules can be used for control of the complex system of FIG. 1, wherein outputs of the complex system can be used as inputs to the computational modules of the computation structure, and wherein results of given computational modules can be presented In a graphical or tabular form to users;

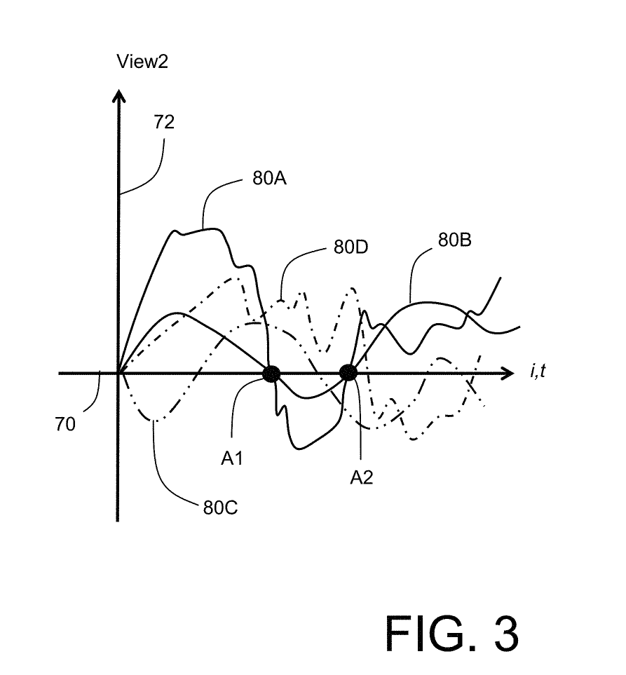

FIG. 3 is a schematic illustration of results generated by the computational structure of FIG. 2, wherein an “Actual” feature of the computational structure enables computations within given computational modules to be constrained (for example A1, A2) to user-defined values for certain stages of execution of a computational task within the computational structure;

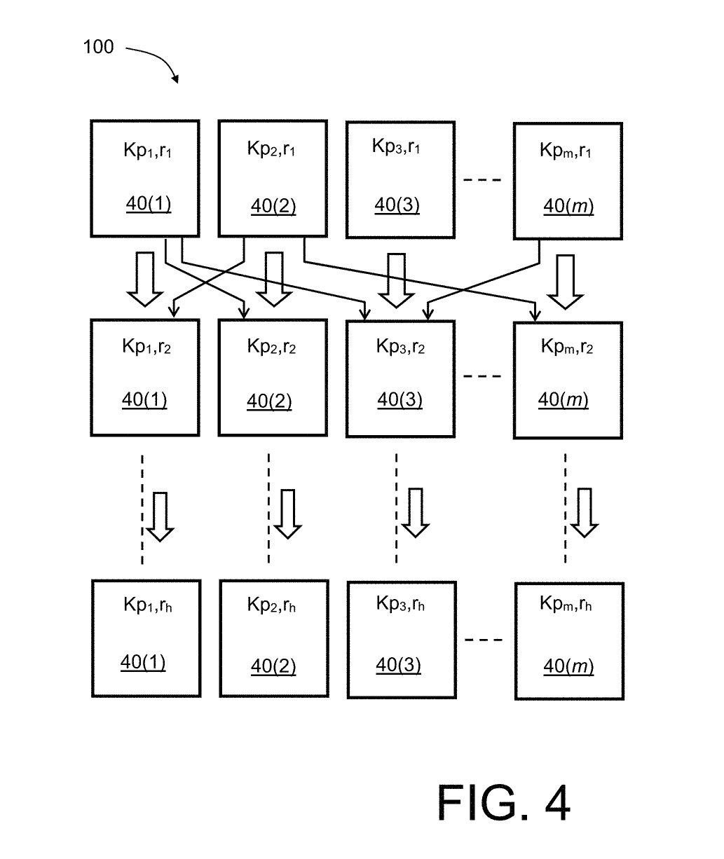

FIG. 4 is an array of computation structures, of a type as illustrated in FIG. 2, optionally with the “Actual” feature of a type of illustrated FIG. 3; the array of computational structures is optionally executed in a conventional computing architecture, in a “cloud” server configuration or in a custom-design digital array processor arrangement;

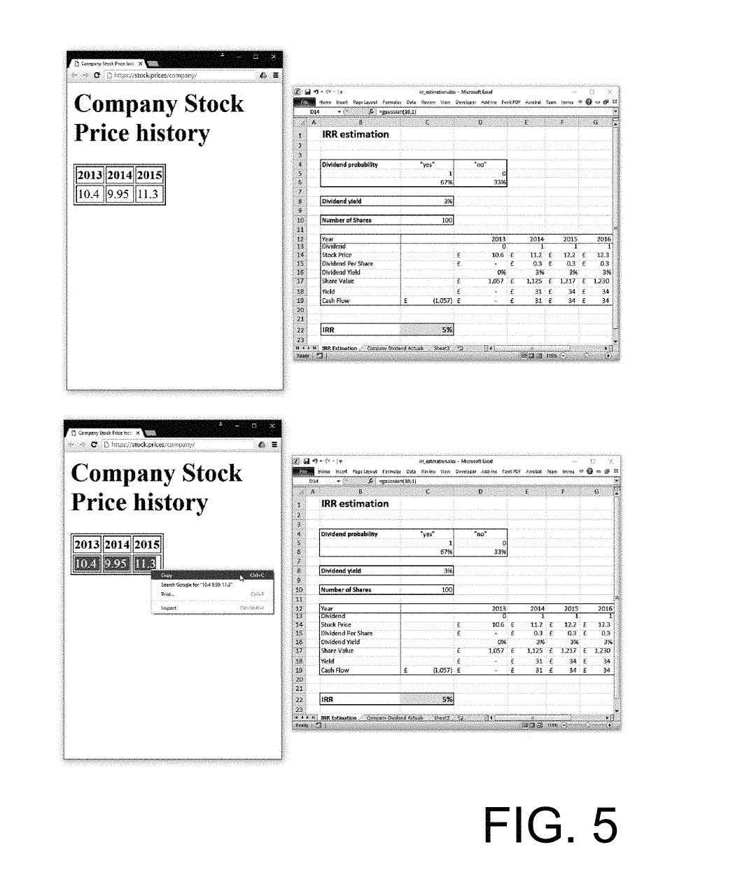

FIG. 5 is an illustration of a reduction to practice of addressable source code transformation mechanism for automatically introducing constraints into data-flow programs from values held in a paste buffer;

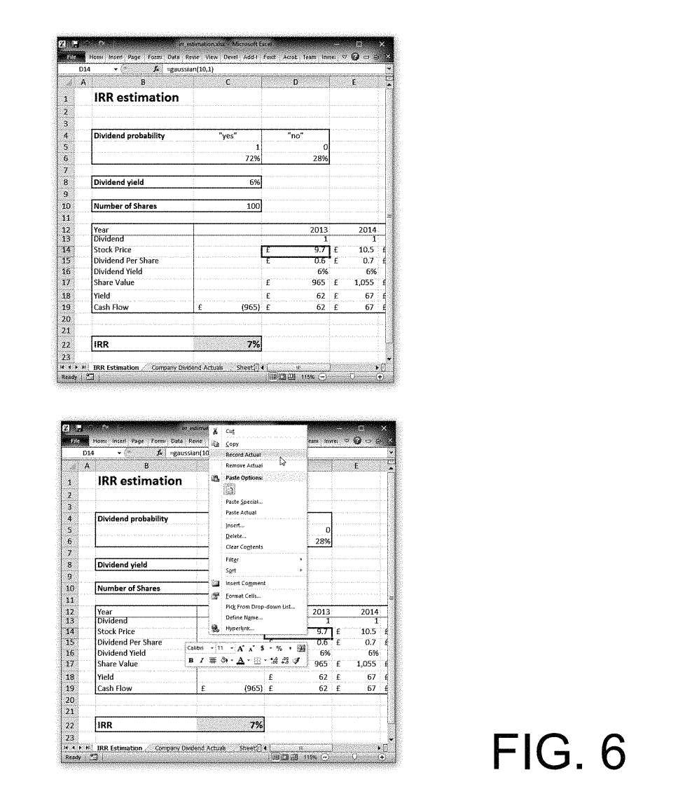

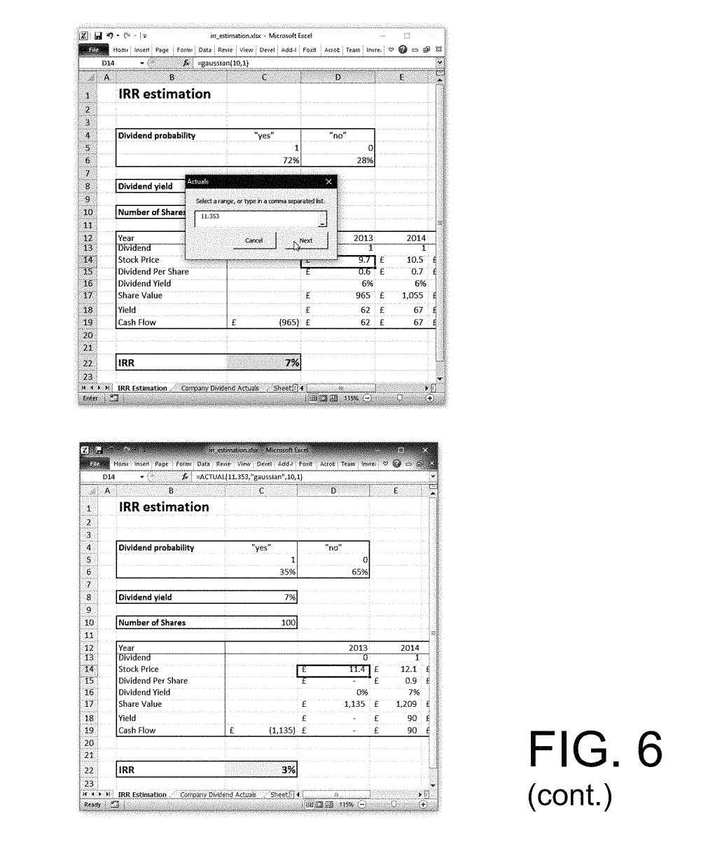

FIG. 6 is an illustration of a reduction to practice of addressable source code transformation mechanism for automatically introducing constraints into data-flow programs from provided values;

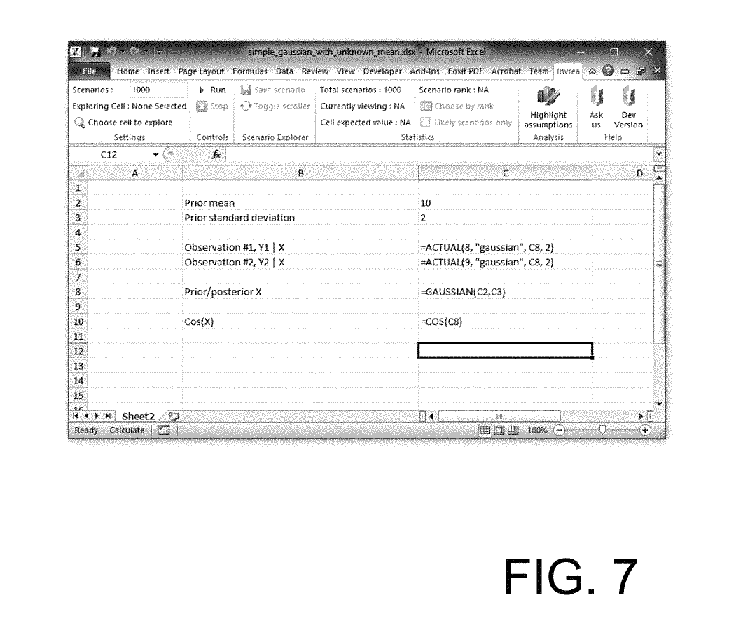

FIG. 7 is an illustration of a simple probabilistic data-flow program (post actual inserting transformations);

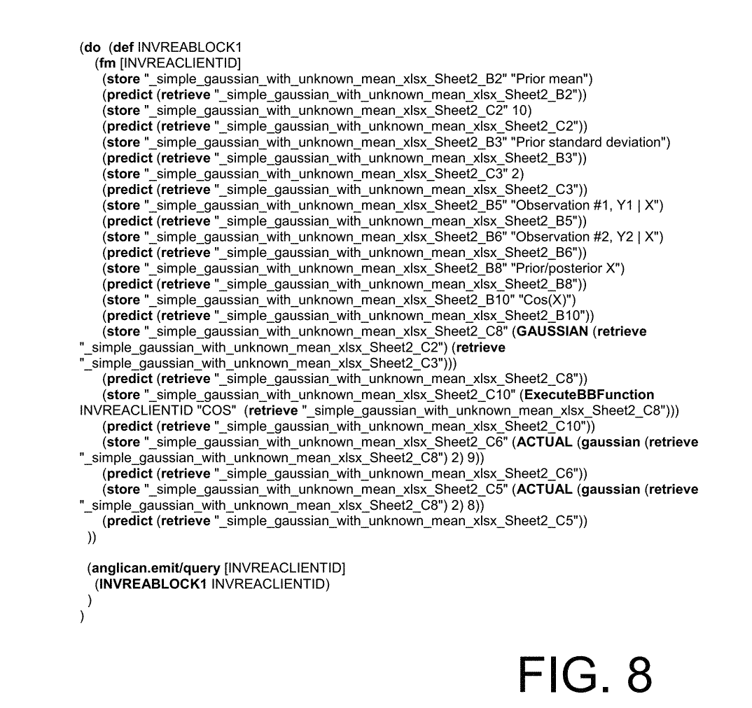

FIG. 8 is an illustration of a “corresponding Anglican program”, namely a result of compiling the data-flow program into a corresponding Anglican program; and

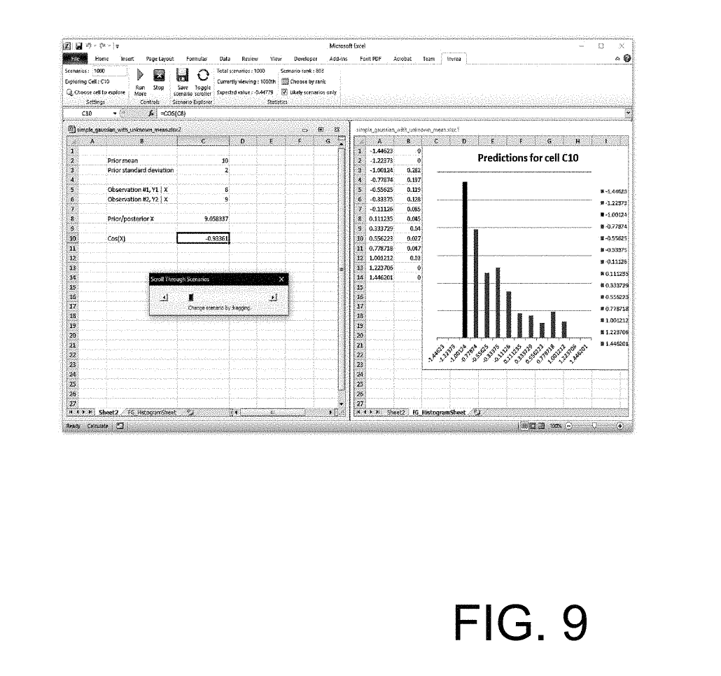

FIG. 9 is an illustration of results of running inference, as opposed to the techniques outlined in the attached paper (APPENDIX 2), in an external engine and shipping the results back for display; notably, these are indistinguishable from running inference using the techniques described in the attached paper (APPENDIX 2); here, an automatically generated histogram of the posterior distribution of values that a cell C10 could have taken whilst cells C5 and C8 are thusly constrained.

In the accompanying diagrams, an underlined number is employed to represent an term over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, embodiments of the present disclosure relate to a computing engine, whether implemented in novel custom-designed digital hardware or by employing arrangements of known computing devices, wherein the computing engine is operable to execute program instructions, for example as provided in software products, to enable the computing engine to execute computations as defined in a plurality of modules, wherein inputs to the modules are optionally provided as at least one of:
(i) one or more user inputs (S1);
(ii) one or more outputs from a complex system (S2); and
(iii) one or more computational results (S3) from other modules of the computing engine.

The computing engine is optionally operated in an iterative manner. Embodiments of the present disclosure are also concerned with program instructions, namely software products, for a computing language for use in implementing the aforementioned computing engine.

Although the computing engine can be used in isolation for performing computations on abstract data to generate corresponding abstract results, the computing engine is most effectively used, pursuant to exemplary embodiments of the present disclosure, for performing simulations for generating predictions and for controlling operation of a real complex system, for example wherein the complex system interacts with real physical variables and one or more real physical processes, for example one or more real physical processes that are susceptible to experiencing random stochastic variations that can influence operation of the real physical processes. Examples of such a real complex system include:
(a) A driverless automobile, namely an automatic computer-steered vehicle, wherein a user input defines a spatial route within a road network and a destination for the route along which the vehicle is required to travel, and wherein sensors of the driverless automobile are operable to sense road conditions and other road vehicles. The trajectories of other road vehicles will not be known a priori and are potentially random, for example in an event that one or more drivers of the one or more other road vehicles make mistakes or momentarily lose control of their vehicles, or unexpected weather conditions cause slippery road surfaces causes the other vehicles to skid, spin or similar. When making the journey in the driverless automobile, repeating travelling along the same user-defined result at different dates will present different challenges for the driverless automobile, because temporal stochastic variation in the trajectories of the other one or more road vehicles will occur. In its simulation, namely anticipating potential mad accidents caused by the other road vehicles, the driverless automobile is required to simulate potential at least partially stochastic trajectories of a plurality of other vehicles. In such a scenario, operation of the computing engine 10 to implement such at least partially stochastic simulation and provide steering and braking commands to a driverless automobile, in response to sensor signals that are capable of providing constraining values, namely aforementioned “Actual” option with reference to FIG. 3;
(b) Industrial processes such as greenhouses for generating crops: greenhouses generally behave in a manner that can be predicted from mass exchange between the given greenhouse and its surrounding environment (for example exchange of water, nutrients, gases), energy exchange between the given greenhouse and its surrounding environment (for example heating applied, heat loss from the given greenhouse, and energy input from ambient sunlight), and elapsed time. Growth and yield of biological plants, for example tomato plants can be approximately predicted, for example using standard plant growth models, although stochastic variations in performance between members of a group of plants are difficult to predict a priori. Unexpected stochastic conditions can also arise whilst plants are growing, for example adverse effects caused by pant disease and insect attack. Moreover, the surrounding environment to the given greenhouse can vary as a function of weather, that has a predictable seasonal component and an unpredictable stochastic component. Commercial profits from selling tomatoes from the given greenhouse will be a temporal integral of plant behaviour whilst the given greenhouse is subjected to aforementioned mass transfer and energy exchange functions. The computing engine 10 is capable of being arranged to function as a highly effective greenhouse controller, wherein there are user inputs and weather forecasting predictions (S1), wherein there are simulations performed in the computing engine 10 regarding stochastic likely growth and potential tomato yield (S3), wherein there are sensor signals from an arrangement of sensors disposed within the given greenhouse (S2), and there are control outputs from the computing engine 10 (Q) that are used to control heating appliances, window actuators, plant watering systems and ventilation fans that are employed to vary a microclimate created within the given greenhouse for the plants; and
(c) a military system, wherein sensors gather in information (S2) regarding enemy assets, wherein a user is able to input commands (S1) to the military system, and wherein one or more simulations are required to assess potential damage that can be inflicted by the enemy assets, taking into account that movements and/or actions of the enemy assets are not known a priori and may be at least partially stochastic (for example to evade detection or being hit), and wherein the military system is required to apply various instructions to a firing system of the military system, for example direction of fire, which missiles, bombs or lasers to fire, at what time to fire, and so forth. The computing engine 10 is capable of providing computations to enable the military system to function in a more optimal manner. Optionally, the military system is of a more abstract nature, namely implemented as a war games interactive games terminal, rather than a real military defence system.

Other examples are feasible pursuant to the present disclosure.

By “complex system” is meant any system that is representative of a real physical system, and optionally includes components of business arrangements, machinery, apparatus, buildings.

The computing engine 10 can be implemented in several ways. A convenient way to appreciate an embodiment of the computing engine 10 is to consider a conventional computer executing a spreadsheet program (software product), for example in a manner to contemporary Excel®. Moreover, it will be appreciated that embodiments of the present invention are not limited to spreadsheet-type programs.

Referring to FIG. 2, there is shown an example of a computation structure indicated generally by 40, for use in the aforementioned computing engine 10. The computation structure 40 can be implemented, for example, in a generally similar manner to a conventional spreadsheet program for a computer. The conventional spreadsheet program, via a graphical user interface (GUI) of the computer, is operable to present a two-dimensional array of cells to a user of the spreadsheet program. Data values can be entered by the user into certain cells of the spreadsheet program (namely “seed values”). Moreover, one or more computational functions for the cells be pre-defined by the user; optionally, the one or more computational functions can include one or more types of random number generator function. The computational functions can be provided with data generated by other cells. The spreadsheet program is then run, taking data values entered by the user (“seed values”), applying the one or more computational functions of the cells to the data values entered by the user to generate final results for presentation. When using the spreadsheet program, the user can inspect values of the cells after the one or more computations of the cells have been completed, or presentation can occur, for example, by generating a graphical plot in respect of a Cartesian coordinate frame, or some other type of coordinate frame (for example a polar frame). A graphical plot is often more intelligible to users, on account of the human mind possessing advanced image processing capabilities (bestowed by evolution).

When the one more computations include one or more random functions, re-running the spreadsheet program can generate statistical spread of results, even when the data values (“seed values”) entered by the user are the same, and the one or more computational functions defined for the cells are unaltered. Re-running the spreadsheet many times enables an estimate of a likely range of outcomes and their probabilities to be determined, namely by way of a Monte Carlo type of simulation.

In FIG. 2, the computational structure 40 includes computational modules 50, corresponding to the cells of the aforementioned spreadsheet program, when presented via the GUI; there are m modules 50 shown in FIG. 2 for illustrative purposes, wherein m is an integer. One or more computational functions f are defined for the modules 50, wherein the computational modules 50 can have mutually different types and numbers of computational functions defined for them; the one or more computational functions can include one or more random generator functions, or other types of stochastic functions. Moreover, the one or more computation functions can also include arithmetic functions, polynomial functions, transcendental functions, logarithmic functions, decision points, conditional looping functionality and similar. When executed, the one or more computational functions f of each cell generate a corresponding result R. The user can define that a given result R of a given computational module 50 can be used subsequently as input data for another computational module 50, for example by way of a data value transfer between modules, as denoted by 60. Moreover, the user can also specify that certain results R are output for graphical viewing, for example “View1” and “View2”. Optionally, one or more of the results R can be output from the spreadsheet program as an output, for example an output “Q1”, for use in controlling a complex real physical system, for example the aforementioned complex system 20. Aforementioned user defined data values, namely “seed values”, are denoted by “start” in FIG. 2. In the spreadsheet program, user data values are specified via invoking a tool bar presented at a peripheral edge, for example top edge, of a field of view provided by the GUI.

Reference is made to the appended APPENDIX 1 and APPENDIX 2 which provide supportive content regarding implementations of the computing engine 10 and its manner of operation. Both APPENDIX 1 and APPENDIX 2 form a part of the present disclosure.

Referring next to FIG. 3, there is shown an illustration of a Cartesian graphical output generated the computational structure 40 of FIG. 2, via the GUI. An abscissa axis 70 of the graphical output denotes iteration number, or time. An ordinate axis 72 of the graphical output denotes, for example, “View2” results R from a given module 50. On account the one or more computational functions of one or more of the computational modules 50 including one or more random number functions, mutually different results are generated by the computational structure 40, as the computational structure 40 is repeatedly re-run. Results of such re-runs are denoted by curves 80A to 80D.

In contradistinction to known conventional spreadsheet programs, the computational structure 40, for example a illustrated in FIG. 2, is operable to provide a novel feature, namely allows the user to apply an “Actual value” in respect of the results R by invoking a “Actual” feature, for example obtained by user choice, user observation, from sensor measurement data of a real physical system, or by way of other simulation. Such an “Actual value”, for example invoked from a toolbar of a spreadsheet-type program, is shown in FIG. 3 as actual values A1 and A2, and constrains computations associated with the curves 80A and 80B; it will be appreciated that there can be more than two “Actual values” employed, or less than two “Actual values” employed, and that the two actual values A1 and A2 are merely for illustrative purposes. Other curves that are not capable of being constrained, namely the curves 80C and 80D, are then not computed by the computational structure 40, thereby saving computing effort, namely freeing up processing capacity; reference is made to APPENDIX 1 and APPENDIX 2 regarding a basis of a manner in which such constraining of “actual values” is implemented in practice in code. The curves 80A, 80B, on account of applying “Actual value”, are constrained at the points A1, A2 at their respective times or iteration in the computation. It will be appreciated that the points A1, A2 do not need necessary to lie along the abscissa axis 70, and can potentially be located anywhere on the Cartesian graphical plot. An effect of “Actual value”, is that the computing engine 10, using the computational structure 40 of FIG. 2, may be performing simulations as a part of its control function, in respect of the complex system 20, and that applying “Actual values” enables uncertainty in the simulation to be reduced, and hence the computing engine 10 is thereby capable of controlling the complex system 20 in a more appropriate manner. For example, in a driverless automobile situation, it is found via sensors that a given other vehicle in a similar spatial vicinity to the driverless automobile has parked and becomes motionless; such a motionless state of the given other vehicle thus becomes such an “Actual value” that enables uncertainty in results generated by the computational structure 40 to be less uncertain, namely lower stochastic spread, thereby increasing driving safety of the driverless automobile.

The computational structure 40, for example as illustrated in FIG. 2, is also novel in respect of known spreadsheet programs in that it provides a “Create” feature, as will next be elucidated in greater detail. In a conventional spreadsheet program, the user defines the one or more computational functions of the computational modules 50 explicitly, even though the one or more computational functions optionally include random number generators, and even conditional branching. The computational structure 40 pursuant to the present disclosure is distinguished from known art, in that it allows the user to define one or more “Actual values”, and the computational structure 40 will then proceed to select from a library of computational functions, one or more computational functions that can be assigned to one or more of the modules 50 so that their output is constrained to the one or more “Actual values”, for given point in executed computations. Optionally, the computational structure 40 is operable to provide a range of possible selected computational functions that will satisfy the one or more “Actual value”, for example with a corresponding indication of probability that the selection is representative of the “Actual value”.

A practical use of such a “Create” feature of the computational structure, pursuant to the present disclosure, for example conveniently invoked from a tool bar of a spreadsheet presentation, via a GUI, is when the computation structure 40 is arranged to control a given greenhouse, and an owner of the given greenhouse introduces a new item of equipment into the greenhouse, for example introduces a colony of bees into the given greenhouse for plant flower pollination purposes, wherein the bees influence a gas and fluid balance of the given greenhouse. From actual values of measured physical sensor data from the given greenhouse, namely by collecting “Actual values” over a period of time, optionally at a plurality of mutually different spatial locations within the given green house, the computation engine 10 is able to create, by invoking the aforementioned “Create” feature, by selecting from a set of potential computational functions, a selected set of functions that represent operating characteristics of the colony of bees. When such a creative selection of computational functions is executed, the computing engine 10 can incorporate such a likely model of the colony of bees into the simulation employed by the computing engine 10 for controlling the greenhouse, for example for predicting a probable range of tomato crop yield and associated financial value of the tomato crop yield, for example adjusted for date when sold via a commercial market for such fruit.

The computational structure 40, denoted by K_{p,r} in FIG. 4, for example as illustrated in FIG. 2, can be employed in an array manner, for example in a manner as illustrated in FIG. 4 wherein there is an array of several computational structures 40(1) to 40(m), wherein m is an integer. FIG. 4 thus represents an example alternative implementation, indicated generally by 100, of the computing engine 10, wherein a top row in the diagram represents the plurality of computational structures 40 that are operable to interact mutually, and successive rows therebelow illustrate a manner in which output data (namely R values from one or more computational modules 50 of the computational structures 40) are exchanged between the computational structures 40, K, for example when the implementation 100 is employed to simulate a complex group of assets, particles, objects or similar, and optionally take action in respect of such assets, particles, objects or similar based upon the simulation. Such an implementation 100 can be based on a conventional von Neumann computer architecture, for example using dual-core or quad-core processor arrangements, or can be based on an array of customized processors coupled together via one or more buses that are operable to enables the computational structures 40(1) to 40(m) to exchange data therebetween.

The implementation 100 is especially useful when each computational structure 40 represents a particle, or cluster of particles, and stochastic trajectories of the particles are being computed as a function of time, t. It is not feasible for the implementation 100 to compute all possible positions of the particles, and hence results from the implementation after h iterations, represents only a sub-set of potential particle trajectories. The implementation 100 is capable, as a novel interpolation feature, of interpolating between a limited subset of computed particle trajectories at the iteration h to map out a region M which all potential trajectories of the particles will lie, namely by way of concurrent Monte Casio simulation. Results of such interpolation then, optionally, enables the computing engine 10, utilizing the implementation 100, to output control signals to the complex system 20 based upon the interpolation. Such a computation pertains, for example, to a nuclear power plant, wherein, after an accident, all potential states of the nuclear power plant have to be taken into consideration, before a course of action is adopted to try to cope with the accident. Such interpolation of results from the implementation is beneficially also included as a toolbar feature, namely “Interpolation”, when the implementation 100 employs, via a GUI, a spreadsheet-type presentation format to enable users to interact with the implementation 100, namely with the computing engine 10.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A computing engine for use in simulating a complex system, controlling the complex system, or a combination of simulating and controlling the complex system, wherein the computing engine includes a data processing arrangement that is operable to execute at least one program instruction,
wherein the computing engine includes a plurality of computational modules that are operable to exchange data therebetween via a data exchange arrangement,
wherein the computational modules are operable to execute at least one computational function therein on data received at the computational modules and to generate corresponding output data,
wherein the computation modules are operable to receive, for input data to at least one computational function, at least one of: user input values, sensed data from the complex system,
wherein the computational modules are operable to output their corresponding output data for at least one of: user presentation, for controlling operation of the complex system,
wherein the computing engine is operable to enable at least one of: constraining of the output data by way of an actual feature, automatically creating by way of a create feature the at least one computational function by way of constraining of the output data by way of an actual feature, interpolating between discrete stochastic output results present in the output data by way of an interpolation feature to determine intermediate stochastic output results lying between the discrete stochastic output results.

2. A computing engine of claim 1, wherein the computing engine is operable to generate a user spreadsheet presentation, for enabling user defining of the at least one computational function of the computational modules and user defining of the user input values.

3. A computing engine of claim 2, wherein at least one of the actual feature, the create feature and the interpolation feature are invoked from a selection presented in a toolbar of the spreadsheet presentation.

4. A computing engine of claim 1, wherein the data processing arrangement is implemented as an array of computing structures that are operable to exchange data therebetween, and to perform repetitive computations for simulating or controlling, or simulating and controlling, trajectories of at least one asset.

5. A computing engine of claim 1, wherein the computing engine is implemented using at least one of: computing hardware, custom hardware logic, a digital array processing arrangement.

6. A system including a complex system and a computing engine as claimed in claim 1, wherein the computing engine is operable to receive at least one sensor signal (S2) from the complex system, and to provide at least one control output signal (Q) for controlling operation of the complex system.

7. A system of claim 6, wherein the complex system includes at least one of: a nuclear power plant, a greenhouse, a driveless vehicle, an aircraft, a robot, a military apparatus.

8. A method of operating a computing engine for use in simulating a complex system, controlling the complex system, or a combination of simulating and controlling the complex system, wherein the computing engine includes a data processing arrangement that is operable to execute at least one program instruction, wherein the method includes:
(a) arranging for the computing engine to include a plurality of computational modules that are operable to exchange data therebetween via a data exchange arrangement;
(b) arranging for the computational modules to be operable to execute at least one computational function therein on data received at the computational modules and to generate corresponding output data;
(c) arranging for the computational modules to be operable to receive, for input data to at least one of their computational functions, at least one of: user input values, sensed data from the complex system;
(d) arranging for the computational modules to be operable to output their corresponding output data for at least one of: user presentation, for controlling operation of the complex system; and
(e) operating the computing engine to enable at least one of: constraining of the output data by way of an actual feature, automatically creating by way of a create feature the at least one computational function by way of constraining of the out data by way of an actual feature, interpolating between discrete stochastic output results present in the output data by way of an interpolation feature to determine intermediate stochastic output results lying between the discrete stochastic output results.

9. A method of claim 8, wherein the method includes operating the computing engine to generate a user spreadsheet presentation, for enabling user defining of the at least computational function of the computational modules and user defining of the user input values.

10. A method of claim 9, wherein the method includes invoking at least one of the actual feature, the create feature and the interpolation feature from a selection presented in a toolbar of the spreadsheet presentation.

11. A method of claim 8, wherein the method includes implementing the data processing arrangement as an array of computing structures that are operable to exchange data therebetween, and to perform repetitive computations for simulating or controlling, or simulating and controlling, trajectories of at least one asset.

12. A method of claim 8, wherein the method includes implementing the computing engine using at least one of: computing hardware, customer hardware logic, a digital array processing arrangement.

13. A computer program product comprising a non-transitory computer-readable storage medium having computer-readable instructions stored thereon, the computer-readable instructions being executable by a computerized device comprising processing hardware to execute a method of claim 8.

14. A computer program product of claim 13, wherein the computer program product includes a computing language for implementing Monte Carlo simulation.

15. A method of transforming in a computing engine a data-flow program into a constrained probabilistic data-flow program, utilizing a plurality of addresses, by using a mechanism that performs a source code transformation, as an alternative to performing a value replacement at each indicated address.

16. A method of executing in a computing engine a data-flow program by repeatedly applying an existing data-flow program execution mechanism to the transformed data-flow program.

17. A method of executing a probabilistic data-flow program in a computing engine (10) by compiling a probabilistic data-flow program to another probabilistic programming language, and using an existing probabilistic program execution mechanism to execute the transformed program on the computing engine or over a data communication network including a data processing arrangement (“cloud computing”).

18. A computer program product comprising a non-transitory computer-readable storage medium having computer-readable instructions stored thereon, the computer-readable instructions being executable by a computerized device comprising processing hardware to execute a method of claim 15.
